(19) United States
(12) Patent Application Publication
(10) Pub. No.: US 2022/0204042 A1
(43) Pub. Date: Jun. 30, 2022

(54) DRIVER MANAGEMENT SYSTEM AND METHOD OF OPERATING SAME

(71) Applicant: HYUNDAI MOBIS Co., Ltd., Seoul (KR)

(72) Inventors: Douglas C. MacKenzie, Livonia, MI (US); Senthil Kumar Seetharaman, Plymouth, MI (US)

(21) Appl. No.: 17/134,450

(22) Filed: Dec. 27, 2020

(51) Int. Cl. B60W 60/00; B60W 40/08; B60W 50/14

(52) U.S. Cl. CPC B60W 60/0051; B60W 60/0059; B60W 60/0016; B60W 40/08; B60W 2050/146; B60W 2040/0818; B60W 2540/229; B60W 2050/143; B60W 50/14

(57) ABSTRACT

A driver management system and a method of operating the same. The driver management system includes: a monitoring part determining a level of driving attention of a driver; and an autonomous driving part receiving the level of driving attention from the monitoring part, determining a level of necessary attention required according to a required level of autonomous driving, and controlling an autonomous driving function of the vehicle according to the required level of autonomous driving when the level of driving attention satisfies the level of necessary attention.

### BACKGROUND

### Field

Exemplary embodiments relate to driver management systems and a methods for operating the same, wherein the driver management system determines a level of driving attention of a vehicle driver, so as to control an autonomous driving function of a vehicle according to a required level of autonomous driving when a level of driving attention satisfies a level of necessary attention required according to the required level of autonomous driving.

### Discussion of the Background

Recently, in autonomous driving of a vehicle, an issue has been raised about how and to what extent a driver's driving intervention is performed in accordance with the autonomous vehicle. In this regard, the Society of Automotive Engineers (SAE) has defined autonomous driving levels of a vehicle, as a total of six levels, from level 0 without autonomous driving to level 5 for fully autonomous vehicles. The degree to which a vehicle driver and a system intervene in the driving of the vehicle differ for each level.

In this case, when a level of autonomous driving is changed while the vehicle is driving, an autonomous driving function according to the level of autonomous driving may be changed only when the driver is ready to intervene, because a degree to which the vehicle driver and the system intervene in the driving of the vehicle is different for each level. However, when the level of autonomous driving is changed while the driver is not ready to intervene, there exists a risk of accidents.

Therefore, there is a need to develop a driver management system that monitors a driver to determine whether the driver is properly intervening in vehicle driving for each level of autonomous driving, or whether the driver is ready for driving intervention when the level of autonomous driving is changed, so as to allow a level of autonomous driving to be changed.

The above descriptions as background arts are only for improving the understanding of the background of the present invention, and should not be accepted as acknowledging that they correspond to the related arts already known to those skilled in the art.

### SUMMARY

Exemplary embodiments of the solve this problem, and an objective of the present invention is to provide a driver management system and a method of operating the same, wherein the driver management system determines a level of driving attention of a vehicle driver to determine a level of necessary attention required according to a required level of autonomous driving, and controls an autonomous driving function of a vehicle according to the required level of autonomous driving when the level of driving attention satisfies the level of necessary attention required according to the required level of autonomous driving.

Additional features of the invention will be set forth in the description which follows, and in part will be apparent from the description, or may be learned by practice of the invention.

A driver management system according to the present invention for achieving the above objective includes: a monitoring part determining a level of driving attention of a driver; and an autonomous driving part receiving the level of driving attention from the monitoring part, determining a level of necessary attention required according to a required level of autonomous driving, and controlling an autonomous driving function of the vehicle according to the required level of autonomous driving when the level of driving attention satisfies the level of necessary attention.

The monitoring part may collect status information on a condition of the vehicle or the driver through a sensor provided in the vehicle, and may determine the level of driving attention of the driver through the status information.

The sensor may include a camera, a biometric sensor, a sound sensor, a motion sensor, or a contact sensor, and may be operated toward the vehicle or the driver from a position inside or outside the vehicle.

The status information may include a driver's gaze, whether a driver's hand is on a steering wheel, or a driver's seat position.

The monitoring part may determine that the level of driving attention of the driver is high when the driver's gaze is directed forward, or when the driver's hand is on the steering wheel, or when the driver's seat position is close to vehicle's acceleration and deceleration devices, and may determine that the level of driving attention of the driver is low when the driver's gaze is directed from a front to another point, or when the driver's hand is not on the steering wheel, or when the driver's seat position is not close to the vehicle's acceleration and deceleration devices.

A notification part may be provided in the vehicle, and the autonomous driving part may operate the notification part to provide the driver with information on the level of necessary attention required according to a changed level of autonomous driving when the required level of autonomous driving is changed.

The autonomous driving part may execute the autonomous driving function of the vehicle according to the changed level of autonomous driving when the level of driving attention of the driver satisfies the level of necessary attention required according to the level of autonomous driving changed within a predetermined time.

The notification part may be provided in the vehicle, and the autonomous driving part may operate the notification part to provide the driver with a warning or the information on the level of necessary attention when the level of driving attention of the driver does not satisfy the level of necessary attention.

The notification part may provide the driver with the warning or the information on the level of necessary attention in a manner including a warning lamp, a voice, or a display inside the vehicle.

The autonomous driving part may update the level of autonomous driving required according to a changed level of driving attention when the level of driving attention of the driver is changed.

A method of operating a driver management system according to the present invention for achieving the above objective includes: monitoring a level of driving attention of a driver, wherein the level of driving attention of the driver is determined; determining a level of necessary attention required according to a required level of autonomous driving; and controlling an autonomous driving function of a vehicle according to the required level of autonomous driving when the level of driving attention determined in the monitoring of the level of driving attention of the driver satisfies the level of necessary attention.

The method of operating a driver management system may further include: notifying the driver, wherein the driver may be warned or provided with information on the level of necessary attention when the level of driving attention of the driver does not satisfy the level of necessary attention, after the controlling of the autonomous driving function of the vehicle.

The method of operating a driver management system may further include updating the level of autonomous driving, wherein the level of autonomous driving required according to a changed level of driving attention may be updated when the level of driving attention of the driver is changed, after the controlling of the autonomous driving function of the vehicle.

According to the driver management system and the method of operating the same of the present invention, the driver management system may determine a level of driving attention of a vehicle driver to determine a level of necessary attention required according to a required level of autonomous driving, and controls an autonomous driving function of a vehicle according to the required level of autonomous driving when the level of driving attention satisfies the level of necessary attention required according to the required level of autonomous driving.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view showing a driver management system according to an exemplary embodiment of the present invention.

FIG. 2 is view showing a flowchart of a method of operating the driver management system according to the exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

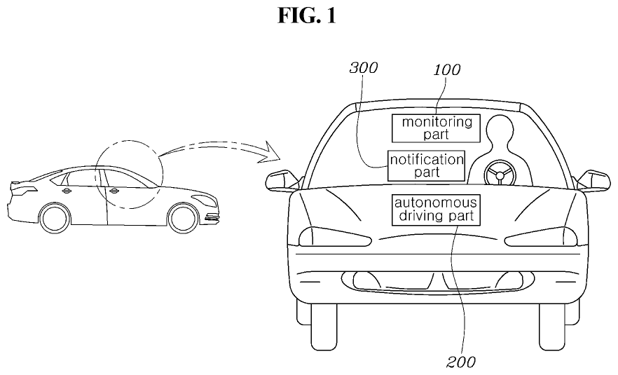

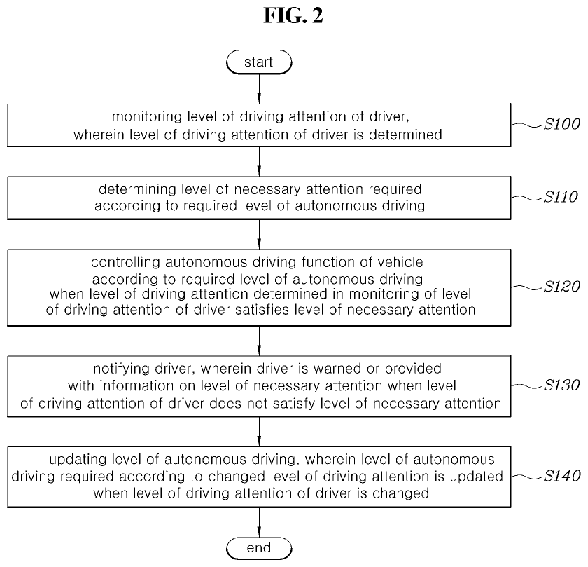

FIG. 1 is a view showing a driver management system according to an exemplary embodiment of the present invention. FIG. 2 is view showing a flowchart of a method of operating the driver management system according to the exemplary embodiment of the present invention.

FIG. 1 is the view showing the driver management system according to the exemplary embodiment of the present invention. A driver management system according to the exemplary embodiment of the present invention includes: a monitoring part 100 for determining a level of driving attention of a driver; and an autonomous driving part 200 for receiving the level of driving attention from the monitoring part 100, determining a level of necessary attention required according to a required level of autonomous driving, and controlling an autonomous driving function of a vehicle according to the required level of autonomous driving when the level of driving attention satisfies the level of necessary attention. The autonomous driving part 200 may be provided in a vehicle or in a server outside the vehicle to communicate with the vehicle, thereby controlling the autonomous driving function of the vehicle.

The monitoring part 100 or the autonomous driving part 200 according to the exemplary embodiment of the present invention may be implemented by applying a nonvolatile memory (not shown) configured to store data relating to an algorithm developed to control operations of various components of the vehicle or software instructions for reproducing the algorithm, and by applying a processor (not shown) configured to perform the operations described below using data stored in the corresponding memory. Here, the memory and the processor may be implemented as separate chips. In the alternative, the memory and the processor may also be implemented as a single chip integrated with each other, and the processor may also take a configuration having one or more processors.

Specifically, levels of autonomous driving of a vehicle are defined as six levels, including: Level 0 in which a driver drives directly; Level 1 in which the driver drives but a system assists in acceleration/deceleration or steering of a vehicle; Level 2 in which the driver drives but the system assists in acceleration/deceleration and steering of the vehicle; Level 3 in which the system operates but the driver immediately drives upon a system request; Level 4 in which the system drives in certain situations and the driver does not intervene; and Level 5 in which the system operates in all situations.

At this time, since the driver's intervention is decreased when the level of autonomous driving is changed from a low level to a high level, it is possible to change the level of autonomous driving when a change is requested without any problems. However, since driver's intervention is required when the level of autonomous driving is lowered from a high level to a low level, the level of autonomous driving may be changed only when the driver is prepared for the driving intervention. Therefore, in the driver management system according to the exemplary embodiment of the present invention, a driver is monitored through the monitoring part 100, thereby monitoring the level of driving attention to determine whether the driver is properly intervening in vehicle driving for each level of autonomous driving, or whether the driver is ready for driving intervention according to a change of level of autonomous driving when the level of autonomous driving is changed. In this regard, the autonomous driving part 200 operates the autonomous driving function according to the level of autonomous driving or changes the level of autonomous driving only when the level of driving attention satisfies the level of necessary attention according to each level of autonomous driving, and thus accidents may be prevented and the vehicle may safely arrive at its destination by using the autonomous driving function.

Meanwhile, in the driver management system according to the exemplary embodiment of the present invention, the monitoring part 100 collects status information on a condition of a vehicle or a driver through a sensor provided in the vehicle, and a level of driving attention of the driver may be determined through the status information.

For example, the monitoring part 100 may use DDREM (Departed Driver Rescue and Exit Maneuver) technology, in which when a driver is unable to drive normally due to such as drowsy driving or cardiac arrest, a vehicle determines a driver's condition and the vehicle is automatically moved and stopped at a safe place such as a road side.

The DDREM technology is a system, in which when a vehicle moves in zigzag due to drowsiness, etc., or when a driver closes his or her eyes frequently without looking ahead, a sensor detects this condition to lead the vehicle to a safe place technically, thereby meaning to rescue a driver who is unable to drive. The DDREM technology uses two core technologies: a Driver Status Warning (DSW) system and a Driver Awareness warning (DAW) system, and the monitoring part 100 may determine a driver's condition, such as the power of attention of a driver or whether the driver is drowsy, by determining whether a driver's gaze is distracted, driver's blinking patterns, etc. through a sensor and the DSW system which are provided in a vehicle, and may determine a vehicle's condition, such as whether the vehicle crosses lanes or shaking of the vehicle, through the sensor and the DAW system. In this way, after collecting status information on the condition of the vehicle or the driver, the monitoring part 100 determines a level of driving attention of the driver on the basis of the status information.

In addition, in the driver management system according to the exemplary embodiment of the present invention, a sensor includes a camera, a biometric sensor, a sound sensor, a motion sensor, or contact sensor and may be operated toward the vehicle or the driver from a position inside or outside a vehicle. In the driver management system according to the exemplary embodiment of the present invention, status information may include a driver's gaze, whether a driver's hand is positioned on a steering wheel, or a driver's seat position.

Meanwhile, in the driver management system according to the exemplary embodiment of the present invention, the monitoring part 100 may determine that a level of driving attention of a driver is high when the driver's gaze is directed forward, or when the driver's hand is on the steering wheel, or when the driver's seat position is close to vehicle's acceleration and deceleration devices, and may determine that the level of driving attention of the driver is low when the driver's gaze is directed from the front to another points, or when the driver's hand is not on the steering wheel, or when the driver's seat position is not close to the vehicle's acceleration and deceleration devices.

Specifically, a level of driving attention may be classified into high, medium, low, etc., and the monitoring part 100 determines that as the driver's gaze is more toward the front, or as the driver's hand is closer to the steering wheel, or as the driver's seat position is closer to vehicle's acceleration and deceleration devices, the level of driving attention of the driver is high, and determines that as the driver's gaze is less toward the front, or as the driver's hand is further from the steering wheel, or as the driver's seat position is further from vehicle's acceleration and deceleration devices, the level of driving attention of the driver is low.

In addition, the autonomous driving part 200 determines a level of necessary attention required for each level of autonomous driving, and in the case of level 0 to level 2, since the driver directly drives the vehicle, the level of necessary attention should be at a high level in which a driver's hand should always be placed on a steering wheel, a driver's gaze should look ahead and pay attention to the front, a driver's seat position should maintain a driver's sitting posture, and a driver's foot should be in a suitable position so that an accelerator or deceleration pedal may be operated at any time.

In the case of level 3 of autonomous driving, since the system directly drives the vehicle, the driver's hand does not need to be always positioned on the steering wheel, the driver's gaze does not have to look ahead, and the driver's seat position may be freely positioned. However, since the driver should be able to intervene in driving without delay within a predetermined period of time in a case where the system requests the driver to intervene in an unexpected situation, the driver must pay attention to the driving to some extent, and thus the level of necessary attention should be at the medium level.

In the case of level 4 of autonomous driving, since the driver's intervention is not required in a specific situation, and the driver's driving intervention is required only in an unexpected situation, the level of necessary attention is low, and in the case of level 5 of autonomous driving, since the driver's intervention is not required in all situations, the level of necessary attention is low.

Accordingly, only when the level of driving attention of a driver determined by the monitoring part 100 satisfies the level of necessary attention for each level of autonomous driving, the autonomous driving part 200 controls an autonomous driving function of a vehicle according to the level of autonomous driving, or changes the level of autonomous driving of the vehicle to control the autonomous driving function of the vehicle according to the changed level of autonomous driving.

Meanwhile, in the driver management system according to the exemplary embodiment of the present invention, a notification part 300 is provided in a vehicle, and when a required level of autonomous driving is changed, the autonomous driving part 200 may operate the notification part 300 to provide a driver with information on the level of necessary attention required according to the changed level of autonomous driving. In addition, the autonomous driving part 200 may execute the autonomous driving function of the vehicle according to the changed level of autonomous driving when the level of driving attention of the driver satisfies the level of necessary attention required according to the level of autonomous driving changed within a predetermined time.

Specifically, when the level of autonomous driving is changed, the level of driving attention of a driver must satisfy the level of necessary attention required according to the changed level of autonomous driving, and in this case the autonomous driving part 200 operates the notification part 300 to provide information on the level of necessary attention required according to the level of autonomous driving to be changed, thereby requesting the driver to intervene in driving. In addition, since sufficient time should be provided to the driver to allow the level of driving attention to be changed when changing the level of autonomous driving, the autonomous driving part 200 changes the level of autonomous driving only when the level of driving attention of the driver is changed within a predetermined time and satisfies the level of necessary attention required according to the level of autonomous driving to be changed. In particular, such a part described above does not cause a problem when the level of autonomous driving is increased, but the importance is further increased when more intervention is required for the driver's driving because the level of autonomous driving is decreased.

In addition, in the driver management system according to the exemplary embodiment of the present invention, the notification part 300 is provided in a vehicle, and when the level of driving attention of a driver does not satisfy the level of necessary attention, the autonomous driving part 200 may operate the notification part 300 to provide the driver with a warning or information about the level of necessary attention. The notification part 300 may provide the driver with the warning or information on the level of necessary attention in a manner including a warning lamp, a voice, or a display inside the vehicle. Since there is a risk of accidents when the level of driving attention of the driver does not satisfy the level of necessary attention according to the level of autonomous driving of the vehicle, the autonomous driving part 200 warns the driver about this unsatisfied condition or provides information on the level of necessary attention, so that the level of driving attention of the driver should satisfy the level of necessary attention according to the current level of autonomous driving while driving.

Meanwhile, in the driver management system according to the exemplary embodiment of the present invention, when a level of driving attention of the driver is changed, the autonomous driving part 200 may update the level of autonomous driving required according to the changed level of driving attention. In this regard, in an unexpected situation, such as when a level of driving attention of a driver is lowered due to an urgent situation such as unconsciousness or drowsy driving, a warning or information is provided to the driver through the notification part 300, and the level of autonomous driving of the vehicle is increased under the determination of the autonomous driving part 200, whereby accidents may be prevented, and the vehicle may be controlled to drive to a place, such as a rest area or hospital, through the autonomous driving function.

FIG. 2 is view showing the flowchart of the method of operating the driver management system according to the exemplary embodiment of the present invention. The method of operating the driver management system according to the exemplary embodiment of the present invention is a method of operating a driver management system, and the method includes: a step S100 of monitoring a level of driving attention of a driver, wherein the level of driving attention of the driver is determined; a step S110 of determining a level of necessary attention required according to a required level of autonomous driving; and a step S120 of controlling an autonomous driving function of a vehicle according to the level of autonomous driving required when the level of driving attention determined in the monitoring of the level of driving attention of the driver S100 satisfies the level of necessary attention.

In addition, after the controlling of the autonomous driving function S120, the method of operating the driver management system according to the exemplary embodiment of the present invention may further include a step S130 of notifying a driver, wherein the driver is warned or provided with information on the level of necessary attention when the level of driving attention of the driver does not satisfy the level of necessary attention.

Meanwhile, after the controlling of the autonomous driving function of the vehicle S120, the method of operating the driver management system according to the exemplary embodiment of the present invention may further include a step S140 of updating the level of autonomous driving, wherein the level of autonomous driving required according to the changed level of driving attention is updated when the degree of diver's driving attention is changed.

Although a preferred embodiment of the present invention has been described for illustrative purposes, those skilled in the art will appreciate that various modifications, additions and substitutions are possible, without departing from the technical scope and spirit of the invention as disclosed in the accompanying claims.

What is claimed is:

1. A driver management system for a vehicle, comprising:
a monitoring part configured to determine a level of driving attention of a driver; and
an autonomous driving part configured to receive the level of driving attention from the monitoring part, determine a level of necessary attention required according to a required level of autonomous driving, and control an autonomous driving function of the vehicle according to the required level of autonomous driving when the level of driving attention satisfies the level of necessary attention.

2. The driver management system of claim 1, wherein the monitoring part is configured to collect status information on a condition of the vehicle or the driver through a sensor provided in the vehicle, and determine the level of driving attention of the driver based on the status information.

3. The driver management system of claim 2, wherein the sensor comprises a camera, a biometric sensor, a sound sensor, a motion sensor, or a contact sensor, and is operated toward the vehicle or the driver from a position inside or outside the vehicle.

4. The driver management system of claim 2, wherein the status information comprises at least one of: a) a driver's gaze, b) whether a driver's hand is on a steering wheel, or c) a driver's seat position.

5. The driver management system of claim 4, wherein the monitoring part is configured to determine that the level of driving attention of the driver is high when at least one of: a) the driver's gaze is directed forward, b) the driver's hand is on the steering wheel, or c) a seat position of the driver is close to an acceleration and deceleration device of the vehicle, and wherein the monitoring part is configured to determine that the level of driving attention of the driver is low when at least one of: a) the driver's gaze is directed from a front of the vehicle to another point not at the front of the vehicle, b) when a hand of the driver is not on the steering wheel, or c) the driver's seat position is not close to the acceleration device or the deceleration device of the vehicle.

6. The driver management system of claim 1, wherein a notification part is provided in the vehicle, and
the autonomous driving part is configured to operate the notification part to provide the driver with information on the level of necessary attention required according to a changed level of autonomous driving when the required level of autonomous driving is changed.

7. The driver management system of claim 6, wherein the autonomous driving part is configured to execute the autonomous driving function of the vehicle according to the changed level of autonomous driving when the level of driving attention of the driver satisfies the level of necessary attention required according to the changed level of autonomous driving changed within a predetermined time.

8. The driver management system of claim 1, wherein a notification part is provided in the vehicle, and
the autonomous driving part is configured to operate the notification part to provide the driver with a warning or the information on the level of necessary attention when the level of driving attention of the driver does not satisfy the level of necessary attention.

9. The driver management system of claim 8, wherein the notification part is configured to provide the driver with the warning or the information on the level of necessary attention in a manner including at least one of: a) a warning lamp, b) a voice, or c) a display inside the vehicle.

10. The driver management system of claim 1, wherein the autonomous driving part is configured to update the level of autonomous driving required according to a changed level of driving attention when the level of driving attention of the driver is changed.

11. A method of operating a driver management system of a vehicle, the method comprising:
monitoring a driver of the vehicle;
determining a level of driving attention of the driver of the vehicle based upon the monitoring of the driver;
determining a level of necessary attention required by the driver according to a required level of autonomous driving; and
controlling an autonomous driving function of the vehicle according to the required level of autonomous driving when the level of driving attention determined in the monitoring of the level of driving attention of the driver satisfies the level of necessary attention.

12. The method of claim 11, further comprising:
notifying the driver when the level of driving attention of the driver does not satisfy the level of necessary attention.

13. The method of claim 11, further comprising:
updating the level of autonomous driving according to a changed level of driving attention when the level of driving attention of the driver is changed.

14. The method of claim 12, wherein the notifying the driver comprises providing the driver with information regarding the level of necessary attention required when the level of driving attention of the driver does not satisfy the level of necessary attention.

15. The method of claim 13, wherein the level of autonomous driving comprises one of six possible levels.

16. A non-transitory computer readable medium comprising program code that, when executed by at least one processor, cause the at least one processor to perform operations comprising:
monitoring a driver of a vehicle;
determining a level of driving attention of the driver of the vehicle based on the monitoring of the driver;
determining a level of necessary attention required by the driver according to a level of autonomous driving required; and
controlling an autonomous driving function of the vehicle according to the required level of autonomous driving when the level of driving attention determined in the monitoring of the level of driving attention of the driver satisfies the level of necessary attention.

17. The non-transitory computer readable medium of claim 16, wherein the program code, when executed by the at least one processor, further causes the at least one processor to perform operations comprising:
notifying the driver when the level of driving attention of the driver does not satisfy the level of necessary attention, after the controlling of the autonomous driving function of the vehicle.

18. The non-transitory computer readable medium of claim 16, wherein the program code, when executed by the at least one processor, further causes the at least one processor to perform operations comprising:
updating the level of autonomous driving according to a changed level of driving attention when the level of driving attention of the driver is changed, after the controlling of the autonomous driving function of the vehicle.

19. The non-transitory computer readable medium of claim 17, wherein the notifying the driver comprises providing the driver with information regarding the level of necessary attention required when the level of driving attention of the driver does not satisfy the level of necessary attention, after the controlling of the autonomous driving function of the vehicle.

20. The non-transitory computer readable medium of claim 16, wherein the level of autonomous driving comprises one of six possible levels.
